(19) United States
(12) Patent Application Publication
(10) Pub. No.: US 2026/0327836 A1
(43) Pub. Date: Oct. 22, 2026

(54) ELECTROLYTIC TREATMENT OF SUBSTRATES CONTAINING COPPER AND/OR ALLOYS THEREOF

(71) Applicant: CHEMETALL GMBH, Frankfurt (DE)

(72) Inventors: Sonja LUX-EHRLICH, Frankfurt (DE); Alexander KOVALENKO, Frankfurt (DE); Joerg HERASIMTSCHUK, Frankfurt (DE); Manfred WALTER, Hanau (DE); Joerg STEINBACH, Frankfurt (DE)

(21) Appl. No.: 19/491,049

(22) PCT Filed: Jun. 19, 2024
(86) PCT No.: PCT/EP2024/067097

§ 371 Date: Dec. 8, 2025

(30) Foreign Application Priority Data
Jun. 20, 2023 (EP) 23180317.2

(51) Int. Cl. C25D 3/54; C25D 5/34; C25D 7/06

(52) U.S. Cl. CPC C25D 3/54; C25D 5/34; C25D 7/0614

(57) ABSTRACT

Disclosed herein is a method for pretreatment of substrates containing copper and/or alloys thereof, the method including contacting at least one surface of the at least one substrate, the surface being made of copper and/or at least one alloy thereof, at least in portion with an aqueous composition and thereby forming a film at least in portion on the surface. Also disclosed herein are a method of applying at least one coating film onto the surface of the pretreated substrate, a substrate obtainable by one of these methods, current collectors, conductors, copper clad laminates, anode materials and battery cells obtainable therefrom, and a use of the aqueous composition for electrolytically forming films on substrates made of copper and/or alloys thereof.

The present invention relates to a method for pretreatment of substrates containing copper and/or alloys thereof, said method making use of a chemical pretreatment composition, a method of applying at least one coating film onto the surface of the chemically pretreated substrate, a substrate obtainable by one of these methods, current collectors, conductors, copper clad laminates, anode materials and battery cells obtainable from such substrates, and to a use of the chemical pretreatment composition applied in the method for pretreatment for forming films on substrates containing copper and/or alloys thereof.

### BACKGROUND OF THE INVENTION

Copper substrates such as copper foils have several advantages like good thermal and electrical conductivities and are widely used, e.g., for connections in electronic circuits and current collectors of battery electrodes.

The copper foils used for these purposes have to be protected from corrosion and/or heat. This is conventionally achieved by application of plating layers to their surfaces. For example, EP 2 544 282 A1 discloses copper foils bearing two kinds of such plating layers, each made of copper metal, the first one obtained by cathode electrolytic plating, for example by making use of a copper-sulfuric acid electrolyte, and the second one applied by smooth copper plating. The resulting plated foils are, e.g., usable for a negative electrode collector of lithium-ion batteries (LIB) and printed circuit boards (PCB). Although it is in general possible to increase the surface roughness of the foil in this manner and, as a result thereof, the adhesion of subsequent coating layers to be applied, the presence of such copper metal plating layers on the foils often hampers the transmission of high frequency electrical currents, which is undesired. Further, the application of the copper plating layers as disclosed in EP 2 544 282 A1 is disadvantageous for economic and ecological reasons, since it requires the performance of additional process steps. Moreover, any additional plating layer present on a copper foil to be used as anode current collector foil adds to the thickness of the copper foil, which is detrimental to the capacity of a resulting battery to volume ratio and, further, makes a recycling process more sophisticated.

It is further known to subject copper foils to a surface treatment instead of merely applying metal plating layers to their surfaces as protective layers. For example, copper foils bearing surface coating layers, which are made from chromium, molybdenum, nickel, and zinc, are disclosed in EP 3 882 378 A1. Moreover, WO 2015/108191 A1 also discloses a surface-treated copper foil, which is obtained by forming a surface treatment layer on top of a copper foil, and which is further etched on the surface that is on the reverse side of the surface on which the surface treatment layer is formed. The surface treatment layer can in particular be a chromate treated layer. Further, CN 112921311 A also discloses a method of coating a surface of a copper foil by making use of an antioxidation liquid for preventing discoloration of the foil. The antioxidation liquid used alia comprises chromic anhydride. In particular for ecological reasons, however, the application of chromium containing coating layers as disclosed in EP 3 882 378 A1, WO 2015/108191 A1, and CN 112921311 A is undesired and to be avoided as much as possible. Further, in case chromium is present in such layers in both different oxidation states such as Cr(III) and Cr(VI), often a non-uniform distribution on the surface of the foil is observed, which is also disadvantageous.

It is additionally known to provide copper foils that have been subjected to a chromium-free surface treatment. For example, CN 103114315 A relates to a chromate-free passivation method of a copper foil. An aqueous tin-containing, i.e., a stannate comprising electrodeposition solution is used for this purpose in order to apply a chromate-free passivation layer onto the surface of the copper foil by an electrolytic treatment. However, also the use of tin in the coating layers described in CN 103114315 A is ecologically undesired. In addition, the resulting layer resembles a tin-containing plating layer, which is disadvantageous, since in general the presence of any other metals than copper present therein is detrimental to the electrical transmission to be achieved and makes the recycling of materials more complex, in particular in case of tin. Further, the use of tin may lead to generation of so-called “metal whiskers”, which is undesired, and, further, the respective tin-containing solutions often are not storage-stable over time.

A number of additional surface treatment methods utilizable for copper substrates are known as well from CN 111118488 A, CN 112144049 A, CN 111364032, JP 2011-023303 A and WO 2007/105800 A1. CN 111118488 A discloses an anti-corrosion passivation method for copper materials, which includes using an organic solvent(s) containing passivation solution being prepared inter alia from ethyl alcohol and polyethylene glycol. It is, however, disadvantageous, e.g., for ecological reasons, to use organic solvents in passivation solutions, in particular in the comparably high amounts used according to the method disclosed in CN 111118488 A. CN 112144049 A discloses a chromium-free passivator for passivating the surfaces of copper substrates, namely an organic inhibitor containing layer prepared from inter alia making use of at least one triazole derivative. However, the presence of such organic coating layers on the surfaces of copper substrates is often detrimental to the adhesion of subsequent coating layers to be applied and, hence, such organic layers must be removed again later on and possibly replaced by other adhesion promoting layers. The removal in turn requires pickling of the foil and/or the use of comparably high amounts organic solvents, both being disadvantageous. CN 111364032 A relates to a surface treating agent of a copper foil, which inter alia comprises different silane coupling agents, namely an alkenyl, mercapto, and isocyanate silane coupling agent, being present in a solvent(s) such as alcohols. The use of surface treating agents as disclosed in CN 111364032 A is, however, disadvantageous, since comparably high amounts of alcohols such as methanol and/or ethanol have to be employed, which is undesirable for environmental and for safety reasons. In addition, due to the presence of the isocyanate silane coupling agent, these surface treating agents have only a comparably low storage stability. Moreover, only an insufficient adhesion of the substrates to subsequently applied coating layers is often observed, when having used the surface treating agents of CN 111364032 A, in particular when the surfaces of the substrates have only low roughness. JP 2011-023303 A discloses a copper foil for a current collector of a lithium-ion battery. The surface of the copper foil has at least in part been subjected to a silane coupling treatment by immersion, spraying, or the like in a non-electrolytic treatment. The method requires comparably high temperatures for curing and even the need to rinse excess silane after the heat treatment. It is, however, disadvantageous, in particular for economic and ecological reasons to have to perform a curing step at such high temperatures and to necessarily have to use an additional rinsing step after the surface treatment has taken place. Finally, WO 2007/105800 A1 discloses a surface treatment liquid for copper materials by use of a copper oxidation etchant such as HMnO₄ or H₂O₂, in a non-electrolytic treatment, which comprises, besides the aforementioned oxidation etchant, a compound containing at least one (semi) metal element selected from inter alia Ti, Zr, and Si and, as an HF supply source, a fluorinated compound. The copper material can be immersed in the surface treatment liquid and the at least one (semi) metal element is deposited by oxidative means. A use of the oxidants described in WO 2007/105800 A1 is, however, disadvantageous, since such oxidants are often hazardous and may lead to strong contamination of the surroundings and/or since such oxidants may be depleted in relatively short time. Further, the oxidants may attack the surface of the copper materials to a too excessive extent if the amounts used thereof are too high. If the amounts are, however, too low, the fluorides of Ti, Zr, and Si formed in the surface treatment liquid are instable, especially when present in an acidic environment.

Thus, there is a need to be able to efficiently provide surface treatment layers on copper substrates such as copper foils in a manner, which is more advantageous compared to the prior art. In particular, there is a need to be able to efficiently provide surface treatment layers on copper substrates such as copper foils in an easy and non-complex, economically and ecologically advantageous manner, which are thin, easy to recycle, provide an excellent electrical transmission to be achieved, but nonetheless allow a good adhesion to subsequently to be applied coating layers on top of the surface treated copper substrates.

### Problem

It has been therefore an objective underlying the present invention to provide surface treatment layers on copper or copper alloy containing substrates such as copper foils in an efficient manner, which is more advantageous compared to the prior art. In particular, it has been an objective underlying the present invention to efficiently provide surface treatment layers on copper or copper alloy containing substrates such as copper foils in an easy and non-complex, economically and ecologically advantageous manner, which layers are thin, allow the substrates to be easy to recycle, provide an excellent electrical transmission to be achieved, but nonetheless allow a good adhesion to subsequently to be applied coating layers on top of the surface treated copper or copper alloy substrates.

### Solution

This objective has been solved by the subject-matter of the claims of the present application as well as by the preferred embodiments thereof disclosed in this specification, i.e., by the subject matter described herein.

A first subject-matter of the present invention is a method for pretreatment of substrates containing copper and/or at least one alloy thereof, the method comprising at least step 1) and optionally steps 2) and/or 3), namely
1) contacting at least one surface of at least one substrate, said surface optionally bearing at least one plating layer, at least in portion with an aqueous composition and thereby forming a film at least in portion on said surface, wherein at least one of (i) the at least one surface of the substrate and (ii) the optionally present plating layer is made of copper and/or at least one alloy thereof, preferably wherein the at least one surface of the substrate is made of copper and/or at least one alloy thereof,
   wherein the aqueous composition preferably contains at least 70 wt.-% of water, based on its total weight, and comprises, besides water, at least one of constituents a1) and a2), which are different from one of another, namely
      at least one of zirconium, titanium, and hafnium cations as constituent(s) a1), preferably in an amount in a range of from 5 to 2000 mg/L, in each case calculated as metal, and/or
      at least one organosilane and/or at least one hydrolysis and/or condensation product thereof as constituent(s) a2), and
2) optionally rinsing the film obtained after step 1) with water, and/or
3) optionally drying the film obtained after step 1) or after optional step 2),
   wherein contacting step 1) is performed in an electrolytic cell arrangement with the substrate containing copper and/or at least one alloy thereof being the cathode during performance of step 1).

A further subject-matter of the present invention is a method of applying at least one coating film onto at least one surface of a substrate, the method comprising at least step 1) and optionally step 2) and/or step 3) as defined hereinbefore in relation to the method for pretreatment, and, further, a step 4), namely
4) applying a coating material composition comprising at least one film-forming polymer onto a film obtained after step 1) or obtained after optional step 2) and/or 3) as defined hereinbefore in relation to the method for pretreatment.

A further subject-matter of the present invention is a substrate obtainable by the aforementioned pretreatment method or by the aforementioned method of applying at least one coating film.

A further subject-matter of the present invention is a component obtainable from the aforementioned substrate, which is selected from current collectors, conductors, copper clad laminates, and anode materials, preferably for use in battery cells such as rechargeable battery cells, or a preferably rechargeable battery cell obtainable from an aforementioned anode material.

A further subject-matter of the present invention is a use of an aqueous composition as defined hereinbefore in connection with contacting step 1) of the pretreatment method for electrolytically forming a film at least in portion onto a surface of a substrate, said surface optionally bearing at least one plating layer, wherein at least one of (i) the at least one surface of the substrate and (ii) the optionally present plating layer is made of copper and/or at least one alloy thereof, preferably wherein the at least one surface of the substrate is made of copper and/or at least one alloy thereof, wherein the substrate serves as cathode for the electrolytic application.

It has been in particular surprisingly found that the films such as conversion films applied in step 1) of the pretreatment method and, in particular, the layers such as conversion layers obtained after drying step 3) can be applied for a passivation on surfaces of copper and/or copper alloy containing substrates such as copper foils in an efficient, easy and non-complex, and also economically and ecologically advantageous manner. It has been found that the films and layers efficiently protect the surfaces of the substrates and the substrates as such during transportation and storage.

Moreover, it has been particularly surprisingly found that these films and layers can be applied in comparably thin dry layer thicknesses, for example corresponding to coating weights in a range of from 0.5 to 500 mg/m², or of from 1 to 400 mg/m², or of from 2 to 350 mg/m², determined in each case as tracer element(s) such as Ti, Zr and/or Si via XRF measurements according to the method disclosed in the ‘method’ section.

It has been in particular found that the copper and/or copper alloy containing substrates can be used as negative electrode, i.e., as cathode, in an electrolytic cell layout, while/during contacting it with the aqueous composition used in step 1) of the pretreatment method as chemical pretreatment composition in order to apply a respective film/layer onto the surface of these substrates.

Further, it has been particularly surprisingly found that the pretreated substrates such as foils obtained after step 1) or after optional step 2) and/or 3) of the pretreatment method provide an excellent electrical transmission with interface resistances of less than 10 mΩ/cm², preferably of less than 3 mΩ/cm, in particular, when the pretreated substrates such as pretreated foils have been incorporated into a battery cell such as a rechargeable battery cell, in particular in the form of an anode (active) material thereof.

In addition, it has been particularly surprisingly found that the pretreated substrates obtainable by the pretreatment method are comparably easy to recycle and in particular do not contain any ecologically and/or environmentally problematic elements and/or compounds.

Finally, it has been particularly surprisingly found that the pretreated substrates obtainable by the pretreatment method provide a good adhesion to subsequently to be applied coating films on top of the pretreated copper and/or copper alloy substrates such as plastic layers, composite layers and in particular other materials used in rechargeable battery cells. The pretreated substrates further have excellent anticorrosion properties.

### DETAILED DESCRIPTION OF THE INVENTION

The term “comprising” in the sense of the present invention, in connection for example with the inventively used aqueous composition, preferably has the meaning of “consisting of”. With regard, e.g., to said composition referred to hereinbefore, it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the compositions add up to 100 wt.-%, based in each case on the total weight of the respective composition.

### Pretreatment Method Including Chemical Pretreatment Step 1)

A first subject-matter of the present invention is a method for pretreatment of substrates containing copper and/or an alloy thereof, preferably of substrates made of copper and/or an alloy thereof. The method comprises at least step 1) and optionally further step(s) 2) and/or 3). The method may comprise further steps performed prior to step 1) and/or after each of steps 1), 2) and 3).

The term “pretreatment” as used herein is preferably used in accordance with the term “surface pretreatment” as defined in Rompp Lexikon “Lacke und Druckfarben” (Publisher: Ulrich Zorll, Editor: Hans-Jürgen P. Adler-Stuttgart; New York: Thieme, 1998; term: “Oberflächenvorbehandlung” page 417). On metallic substrates or substrates having metallic surfaces, according to DIN 50902:1994-07, the first step(s) of a surface treatment is/are often one or more (chemical) cleaning step(s) with aqueous or non-aqueous cleaning compositions (also called “surface preparation step”). Consequently, as it will be outlined hereinafter, the method may comprise one or more further optional steps performed prior to step 1).

The term “chemical pretreatment” is used in accordance with EN ISO 4618:2006 (E/F/D) (term: 2.41 “chemical pre-treatment”), which represents any chemical process applied to a surface prior to the application of a coating material. According to this standard, e.g., treatments like chromatizing (chromating) and phosphatizing, which can be subsumed under the term “conversion treatment”, belong to the chemical pretreatment and thus are to be distinguished from (subsequent) coating steps, wherein coating materials, i.e., coating compositions such as powder coating compositions, electrodeposition coating compositions, aqueous or non-aqueous liquid coating materials are applied. Besides conversion treatments such as chromatizing (chromating) and phosphating, the chemical surface pretreatment may be achieved with passivation compositions and thin-film forming compositions in general, including the aqueous containing composition, which is mandatorily used as chemical pretreatment composition in step 1). Hence, step 1) of the method represents a chemical pretreatment step and the aqueous composition used therein represents a chemical pretreatment composition.

In accordance with the above internationally valid definitions of a “pretreatment” of metallic substrates, the pretreatment method according to the present invention preferably encompasses surface preparing cleaning steps besides the chemical pretreatment step 1).

Preferably, the pretreatment method does not contain any step involving any treatment with chromium ions such as Cr(VI) ions and/or Cr(III) ions.

Preferably, the chemical pretreatment step 1) is the only chemical pretreatment step of the pretreatment method. Hence, preferably, other chemical pretreatment compositions than the aqueous composition applied in step 1) are not used.

Preferably, the film obtained after step 1) or after optional steps 2) and/or 3) has a dry film thickness corresponding to a coating weight in a range of from 0.5 to 500 mg/m², more preferably of from 1 to 400 mg/m², even more preferably of from 2 to 350 mg/m², determined in each case as tracer element(s) such as Ti, Zr and/or Si via XRF measurements according to the method disclosed in the ‘method’ section.

### Substrate

The substrate has at least one surface, wherein at least said at least one surface and/or the at least one optionally present plating layer, which is optionally present on top of said surface, is made of copper and/or at least one alloy thereof. Preferably, the substrate as such is made of copper and/or an alloy thereof, more preferably of a copper alloy. In case of an alloy, copper is the main ingredient of the alloy, based on the total weight of the alloy. Possible alloy ingredients besides copper include nickel, tin, zinc and/or chromium. Examples of commercially available substrates are copper foils NC-WS and FT-UP by Furukawa Electric, copper foils BFL-NN and BF-PLSP by Circuit Foil or copper alloy foils HS1200 by JX Nippon Mining & Metals.

The substrate can be plated or non-plated, i.e., can optionally bear at least one plating layer made of at least one metal and/or an alloy thereof, on at least one of its surfaces, in particular on its surface, which is contacted in step 1) of the method with the aqueous composition. The optionally present at least one plating layer is preferably made of at least one of copper, zinc, nickel, tin, and/or an alloy of one or more of the aforementioned metals. It is possible that one or more such as two or even more than two plating layers are present. For example, in particular when the substrate is a foil and is suitable for being used in printed circuit board (PCB) applications, at least one surface of the substrate bears at least one plating layer in order to achieve sufficient protection from heat.

The substrate can have all sorts of geometry and shape such as coils and sheets and foils as well as other parts, e.g., bars. Preferably, the substrate is in form of a foil a coil or a mostly flat part. Preferably, the foil has a thickness in a range of from 1 μm or 2 μm to 10 or 8 or 5 mm. More preferably, the foil has a thickness in a range of from 1 μm or 2 μm to 4 or 6 mm.

### Optional Steps Performed Prior to Step 1)

Prior to step 1) one or more of the following optional steps can be performed in this order:
Step A-1): cleaning and optionally subsequently rinsing the surface of the substrate,
Step B-1): subjecting the surface of the substrate to acidic pickling, optionally supported by one or more oxidizing agents, i.e., etching, and subsequently rinsing the surface of the substrate,
Step C-1): contacting the surface of the substrate with an aqueous composition comprising at least one mineral acid or alternatively with an aqueous alkaline composition or pH-neutral aqueous composition, each of these compositions being different from the aqueous composition used in step 1), and
Step D-1): rinsing the surface of the substrate obtained after the contact according to step C-1) and/or B-1).

Alternatively, optional steps A-1) and B-1) may be performed in one step. Optional step C-1) preferably serves to remove oxides from the surface of the substrate and to thereby activate the surface for the subsequent treatment in step 1). Preferably, the at least one mineral acid of the composition in step C-1) is sulfuric acid and/or nitric acid, more preferably sulfuric acid. Rinsing step D-1) and the optional rinsing being part of step A-1) are preferably performed by using deionized water or tap water. Preferably, step D-1) is performed by using deionized water.

### Step 1)

According to step 1) of the pretreatment method at least one surface of the at least one substrate is contacted at least in portion with an aqueous composition and thereby a film is formed at least in portion on said surface. The contacting step 1) is performed in an electrolytic cell arrangement with the substrate made of copper and/or at least one alloy thereof being the cathode (negative electrode in an electrolytic cell) during performance of step 1).

By performing step 1) a conversion film is formed on the surface of the substrate, which has been in contact with the aqueous composition. The film formed by contacting step 1) hence preferably represents a conversion film and can also be regarded as passivation film.

The term “at least in portion” preferably means in this context, in accordance with the general understanding of said term, that in some cases it might be desired or sufficient to contact not the whole surface of the substrate with the chemical pretreatment composition. If only part of the surface is contacted with the composition, it is typically the same part for all steps of the method. The surface of the substrate or the substrate as such can be, e.g., immersed completely or only partially. In the latter case only onto the immersed area the aqueous composition will be applied. However, generally, it is desired to contact the whole surface of the substrate the respective compositions.

The “contacting” according to step 1) can be a dipping (immersing) or roll coating (rolling) step. The contacting technique used merely has to allow the formation of an electric circuit during step 1), with the substrate functioning as cathode (negative electrode) of the electrolytic cell arrangement formed.

The at least one surface of the at least one substrate can be brought in direct contact to a power supply, for example with one or more clamps, or a conductive holding system can be used for this purpose. One or more counter-electrodes on one or both sides of the substrate can be installed, preferably parallel to the substrate. The counter-electrodes can be made of any conductive material, preferably metal. In case of using fluoride containing compositions as aqueous composition in step 1) the resistance to the composition has to be considered and taken into account.

Step 1) can be performed in a continuous or discontinuous manner. When step 1) is performed continuously, e.g., in the form of contacting a coil or a foil with the aqueous composition, the contacting can be achieved by conductive rollers. The coil or foil will preferably move parallel to the one or more counter electrode(s) at least partly immersed in the pretreatment bath obtained from the aqueous composition.

During performance of step 1), the pretreatment bath obtained from the aqueous composition can be non-agitated or preferably agitated, preferably in such a way, that there is a quasi-laminar flow of the pretreatment liquid present in the pretreatment bath around the substrate to be treated.

The treatment time, i.e., the period of time the surface is contacted with the aqueous composition in step 1), is preferably from 1 second to 5 minutes, more preferably from 2 seconds to 2.5 minutes or to 1 minute, and most preferably 2 seconds to 30 seconds.

The temperature of the aqueous composition used in step 1) is preferably of from 5 to 90 °C, more preferably of from 15 to 70 °C and most preferably from 20 to 60 °C.

Preferably, the film obtainable after step 1)—after drying according to optional step 3)—, has a coating weight determined by XRF (X-ray fluorescence spectroscopy) of:

0.5 to 500 mg/m², more preferably 1 to 400 mg/m², even more preferably 2 to 350 mg/m², still more preferably 3 to 300 mg/m², of silicon, zirconium, titanium and/or hafnium ions, each calculated as metal or element.

Preferably, the electrolytic treatment according to step 1) performed with direct current, more preferably using a voltage in a range of from 2 to 10 V, even more preferably in a range of from 3 to 8 V, preferably while generating a current density in a range of from 2 to 30 A/m², more preferably in a range of from 3 to 20 A/m².

### Aqueous Composition Used in Step 1)

The aqueous composition used in step 1), which is hereinafter or hereinbefore also referred to as “pretreatment composition” or “chemical pretreatment composition”, comprises, besides water, at least one of constituents a1) and a2), which are different from one of another, namely at least one of zirconium, titanium and hafnium cations as constituent(s) a1), and/or at least one organosilane and/or at least one hydrolysis and/or condensation product thereof as constituent(s) a2).

The term “aqueous” with respect to the inventively used composition in the sense of the present invention preferably means that the aqueous composition is a composition containing at least 50 wt.-%, preferably at least 60 wt.-%, more preferably at least 70 wt.-% in particular at least 80 wt.-%, most preferably at least 90 wt.-% of water, based on its total content of organic and inorganic solvents including water. Thus, the composition may contain at least one organic solvent besides water—however, in an amount lower than the amount of water present. As it will be outlined hereinafter, however, the aqueous composition does not or essentially does not contain any organic solvent(s).

Preferably, the aqueous composition contains at least 50 wt.-%, preferably at least 60 wt.-%, more preferably at least 70 wt.-% in particular at least 80 wt.-%, most preferably at least 90 wt.-% of water, in each case based on its total weight.

Preferably, the pretreatment composition is free or is essentially free of organic solvents. “Essentially free” in this context means that at least on purpose organic solvents are not added, but it may not be ruled out that any of these may be present as impurities. Preferably, the amount of organic solvent(s) present in the aqueous composition does not exceed 5 wt.-%, yet more preferably does not exceed 2.5 wt.-%, even more preferably is lower than 2.0 wt.-%, most preferably is at most 1.0 wt.-% or at most 0.5 wt.-% or at most 0.1 wt.-%, in each case based on the total weight of the composition.

Preferably, the aqueous composition used in step 1) has a pH value in a range of from 1.0 to 9.0, more preferably of from 1.5 to 7.0, even more preferably of from 2.0 to 6.5. Preferably, the pH value is measured at room temperature (23 °C). Preferably, the aqueous composition used in step 1) is acidic, i.e., the pH value is below 7.0, more preferably below 6.5. The pH value of the aqueous composition can be preferably adjusted by using at least one acid such as nitric acid, or at least one alkalinity inducing agent such as aqueous ammonia and/or sodium carbonate if necessary.

Preferably, the aqueous composition is an aqueous solution. Solubility is determined at a temperature of 20 °C and atmospheric pressure (1.013 bar).

Preferably, the pretreatment composition is free or is essentially free of chromium ions such as Cr(VI) ions and/or Cr(III) ions. “Essentially free” in this context means that at least on purpose chromium ions are not added, but it may not be ruled out that any of these may be present as impurities. Preferably, the amount of chromium ions present in the aqueous composition does not exceed 100 mg/L, calculated as metal.

Preferably, the pretreatment composition is free or is essentially free of nickel ions. “Essentially free” in this context means that at least on purpose nickel ions are not added, but it may not be ruled out that any of these may be present as impurities. Preferably, the amount of nickel ions present in the aqueous composition does not exceed 0.2 g/L, calculated as metal, yet more preferably does not exceed 0.1 g/L, even more preferably is lower than 0.1 g/L, most preferably is at most 0.05 g/L, e.g., is in a range of from 0 or 0.001 to 0.05 g/L, in each case calculated as metal.

Preferably, the pretreatment composition is free or is essentially free of tin ions. “Essentially free” in this context means that at least on purpose tin ions are not added, but it may not be ruled out that any of these may be present as impurities. Preferably, the amount of tin ions present in the aqueous composition does not exceed 0.2 g/L, calculated as metal, yet more preferably does not exceed 0.1 g/L, even more preferably is lower than 0.1 g/L, most preferably is at most 0.05 g/L, e.g., is in a range of from 0 or 0.001 to 0.05 g/L, in each case calculated as metal.

### Constituent a1)

If the aqueous composition comprises at least one constituent a1), which it preferably does, said constituent a1) is selected from zirconium, titanium and hafnium cations and mixtures thereof. Preferably, the aqueous composition comprises at least one of zirconium and titanium cations, more preferably at least zirconium cations, as constituent(s) a1).

Preferably, the aqueous composition comprises the at least one constituent a1) in an amount in a range of from 5 to 2000 mg/L, more preferably of from 7.5 to 1500 mg/L, even more preferably of from 10 to 1000 mg/L, still more preferably of from 15 to 500 mg/L, in each case calculated as metal.

Preferably, a precursor metal compound is used to generate the at least one metal cation being present as constituent a1). Preferably, the precursor metal compound is water-soluble. Solubility is determined at a temperature of 20 °C and atmospheric pressure (1.013 bar). Particularly preferred zirconium, titanium and/or hafnium compounds for use as precursor compounds are the complex fluorides of these metals.

The term “complex fluoride” includes the single and multiple protonated forms as well as the deprotonated forms. It is also possible to use mixtures of such complex fluorides. Complex fluorides in the sense of the present invention are complexes of metal cations such as zirconium, titanium and/or hafnium cations formed with fluoride ions in the composition, e.g., by coordination of fluoride anions to zirconium, titanium and/or hafnium cations in the presence of water. The content of the at least one metal cation can be monitored and determined by the means of ICP-OES (optical emission spectroscopy with inductively coupled plasma). Said method is described hereinafter in the ‘method’ section. In case complex fluorides of at least one of zirconium, titanium and/or hafnium cations have been used as precursor compounds, the aqueous composition further comprises fluoride anions as constituent a3).

### Constituent a2)

If the aqueous composition comprises at least one constituent a2), said constituent a2) is selected from at least one organosilane and/or at least one hydrolysis and/or condensation product thereof, as well as mixtures thereof.

Preferably, the aqueous composition comprises at least one of organoalkoxysilanes, organosilanols, polyorganosilanols and mixtures thereof as constituent(s) a2). More preferably, the at least one organosilane and/or a hydrolysis and/or condensation product thereof as constituent(s) a2). Preferably, constituent a2) is selected from silanes, silanols, siloxane and/or polysiloxanes. Preferably, constituent a2) has at least one functional group selected from (meth)acrylate groups, alkylaminoalkyl groups, alkylamino groups, alkyldisulfide groups, alkyltetrasulfide groups, amino groups, aminoalkyl groups, carboxyl groups, epoxy groups, glycidoxy groups, hydroxyl groups, isocyanato groups, mercaptoalkyl groups, succinic anhydride groups, and/or ureido groups (urea groups).

Examples are, e.g., (3-aminopropyl)trimethoxysilane, (3-aminopropyl)triethoxysilane, N-2-aminoethyl-3-aminopropyltrimethoxysilane, (3-butylaminopropyl)trimethoxysilan, bis(3-triethoxysilylpropyl)disulfide, bis(3-triethoxysilylpropyl)tetrasulfide), bis(3-trimethoxysilylpropyl)disulfide, bis(3-trimethoxysilylpropyl)tetrasulfide), 1,2-bis(triethoxysilyl) ethane, (3-mercaptopropyl)trimethoxysilane, (3-mercaptopropyl)triethoxysilane, (3-methylaminopropyl)triethoxysilan, (3-methylaminopropyl)trimethoxysilan, (3-glycidyloxypropyl)trimethoxysilane and/or (3-glycidyloxypropyl)triethoxysilane, and/or vinyltrimethoxysilane. The organosilane is preferably present in a hydrolyzed form thereof.

Preferably, the aqueous composition comprises the at least one constituent a2) in an amount in a range of from 5 to 20 000 mg/L, more preferably of from 10 to 15 000 mg/L, even more preferably of from 20 to 10 000 mg/L, still more preferably of from 30 to 8 000 mg/L, yet more preferably of from 50 to 5 000 mg/L, in each case calculated as elemental silicon.

### Further Optional Constituents Including Constituent a3)

All further constituents optionally present in the aqueous composition such as constituent a3) are different from one of another and also from both constituents a1) and a2).

Optionally, and preferably, the aqueous composition comprises fluoride anions including complex fluoride anions as constituent a3). It is, however, also possible that the aqueous composition is free or essentially free of fluoride anions.

Preferably, the aqueous composition comprises the at least one constituent a3) in an amount of from 0 or 10 to 2000 mg/L, more preferably of from 0 or 15 to 1500 mg/L, even more preferably of from 0 or 20 to 1000 mg/L, still more preferably of from 0 or 25 to 500 mg/L, yet more preferably of from 0 or 25 to 500 mg/L, in each case calculated as fluorine. As it will be outlined hereinafter and as it has already been outlined hereinbefore, preferably complex fluorides such as complexes of zirconium, titanium and/or hafnium formed with fluoride ions are present in the aqueous composition, e.g., by coordination of fluoride anions to zirconium, titanium and/or hafnium cations in the presence of water. Alternatively, fluoride anions may be generated by adding other water-soluble fluorine compounds, e.g., fluorides (other than complex fluorides of Ti, Zr and/or Hf) as well as hydrofluoric acid to the composition. The free fluoride content is determined by means of a fluoride ion sensitive electrode according to the method disclosed in the ‘methods’ section.

Optionally, and preferably, the aqueous composition comprises fluoride anions being present therein as complex fluoride anions as constituent a3), which are preferably coordinated to at least one of zirconium, titanium and hafnium cations being also present in the composition as constituent(s) a1).

Following combinations of essential constituents can be used in particular:
a) Hexafluorozirconic acid
b) Zirconium nitrate
c) Hexafluorozirconic acid and zirconium nitrate
d) Hexafluorotitanic acid
e) Hexafluorozirconic acid and hexafluorotitanic acid
f) Hexafluorotitanic acid and zirconium nitrate
g) Hexafluorozirconic acid, hexafluorotitanic acid and zirconium nitrate
h) organosilane compound(s)
i) organosilane compounds and hexafluorozirconic acid

Optionally, the aqueous composition may comprise further constituents such as other metal cations (other than Zr, Ti and/or Hf) and/or at least one water-soluble polymer such as a water-soluble polymer having at least one kind of functional groups selected from acid groups, hydroxyl groups, and mixtures thereof. Preferably, the at least one water-soluble polymer if present is a homopolymer or copolymer obtainable from polymerization of at least one kind of ethylenically unsaturated monomers, wherein at least part of said monomers bear at least one kind of functional groups selected from acid groups, hydroxyl groups, and mixtures thereof, more preferably is a homopolymer or copolymer obtainable from polymerization of at least one kind of vinyl monomers and/or (meth)acrylic monomers, wherein at least part of said monomers bear at least one kind of functional groups selected from acid groups, hydroxyl groups, and mixtures thereof.

Optionally, the aqueous composition may comprise further constituents such as surfactants, pH adjusting agents such as inorganic acids and salts thereof, organic acids and salts thereof, and/or rheology additives.

### Optional Step 2)

In optional step 2) the film obtained after step 1) is rinsed with water, preferably with deionized water or tap water, more preferably with deionized water. The term “rinsing” preferably means, in accordance with the general understanding of this term, a removal excessive parts of the aqueous composition, which was contacted with the surface in the step directly preceding the rinsing step.

Optional step 3)

In optional step 3) the film obtained after step 1) or after optional step 2) is dried.

Drying may be performed, when in a step 4) as outlined hereinafter, e.g., a coating material composition is subsequently applied. However, step 3) is only optional and, hence, further method steps such as step 4) may be carried out without drying the film obtained. In particular, it is possible to apply a coating material composition in a step 4) as outlined hereinafter onto a wet film obtained after having performed step 1) as well.

The drying step 3) may be preferably performed, e.g., at a temperature in the range of 15 °C to 100 °C, more preferably at a temperature in the range of 18 °C to 95 °C, in particular at a temperature in the range of 20 °C to 90 °C. “Drying” in the sense of the present invention means physical drying by evaporation of in particular water originally present in the composition(s) used. Once a film is dried, the resulting product can be regarded as a layer.

Substrate with Chemically Pretreated Surface, Obtainable by Pretreatment Method

A further subject-matter of the present invention is a substrate obtainable by the aforementioned pretreatment method, i.e., a pretreated and in particular chemically pretreated substrate.

All preferred embodiments described above herein in connection with the pretreatment method and preferred embodiments thereof are also preferred embodiments of the substrate obtainable by this method.

### Method of Applying at Least One Coating Film

The method of applying at least one coating film onto at least one surface of a substrate comprises at least step 1) and optionally step 2) and/or step 3) as defined hereinbefore in relation to the method for pretreatment, and, further, a step 4), namely
4) applying a coating material composition comprising at least one film-forming polymer onto a film obtained after step 1) or obtained after optional step 2) and/or 3) as defined hereinbefore in relation to the method for pretreatment.

All preferred embodiments described above herein in connection with the pretreatment method, the substrate obtainable by this method and in each case preferred embodiments thereof are also preferred embodiments of the method of applying at least one coating film.

### Substrate Obtainable by Method of Applying at Least One Coating Film

A further subject-matter of the present invention is a substrate obtainable by the aforementioned method of applying at least one coating film.

All preferred embodiments described above herein in connection with the pretreatment method, the substrate obtainable by this method, and the method of applying at least one coating film, and in each case preferred embodiments thereof are also preferred embodiments of substrate obtainable by this latter method.

Component Such as Current Collectors, Conductors, Copper Clad Laminates, Anode Materials and Battery Cells Obtainable from Said Anode Materials

A further subject-matter of the present invention is a component obtainable from the aforementioned substrate, which is selected from current collectors, conductors, copper clad laminates, and anode materials, preferably for use in battery cells such as rechargeable battery cells, or a preferably rechargeable battery cell obtainable from an aforementioned anode material.

All preferred embodiments described above herein in connection with the pretreatment method, the substrate obtainable by this method, the method of applying at least one coating film, the substrate obtainable by this method, and in each case preferred embodiments thereof are also preferred embodiments of the anode material and battery cell obtainable.

### Use of the Aqueous Composition for Electrolytic Treatment

A further subject-matter of the present invention is a use of an aqueous composition as defined hereinbefore in connection with contacting step 1) of the pretreatment method for electrolytically forming a film at least in portion onto a surface of a substrate, said surface optionally bearing at least one plating layer, wherein at least one of (i) the at least one surface of the substrate and (ii) the optionally present plating layer is made of copper and/or at least one alloy thereof, wherein the substrate serves as cathode for the electrolytic application.

All preferred embodiments described above herein in connection with the pretreatment method, the substrate obtainable by this method, the method of applying at least one coating film, the substrate obtainable by this method, the aforementioned components, and in each case preferred embodiments thereof are also preferred embodiments of the aforementioned inventive use.

### Methods

### 1. Free Fluoride Content Determination

The free fluoride content is determined by means of a fluoride ion selective electrode. The electrode is calibrated using at least three master solutions with known fluoride concentrations. The calibration process results in the building of calibration curve. Then the fluoride content is determined by using of the curve.

### 2. ICP-OES

The amounts of certain elements in a sample under analysis, such as of zirconium, titanium, hafnium etc., is determined using inductively coupled plasma atomic emission spectrometry (ICP-OES) according to DIN EN ISO 11885 (date: Sep. 1, 2009). A sample is subjected to thermal excitation in an argon plasma generated by a high-frequency field, and the light emitted due to electron transitions becomes visible as a spectral line of the corresponding wavelength and is analyzed using an optical system. There is a linear relation between the intensity of the light emitted and the concentration of the element in question. Prior to implementation, using known element standards (reference standards), the calibration measurements are carried out as a function of the particular sample under analysis. These calibrations can be used to determine concentrations of unknown solutions such as the concentration of the amount of titanium, zirconium and hafnium.

3. Coating weight

XRF (X-ray fluorescence spectroscopy) is used for determining the coating weight in mg/m² of a certain (tracer) element(s) such as Ti, Zr and/or Si in a layer such as the conversion layer resulting from applying the chemical pretreatment composition to a substrate.

### 4. Adhesion

Adhesion was tested by determining the adhesion force using a lap shear test with a 2-component epoxy-type adhesive according to DIN 1465 (07-2009) on a chemically pretreated copper containing substrate and compared with results from the same test made with a copper containing substrate, which had not been subjected to a chemical pretreatment.

Alternatively, adhesion was determined using a tensile force test according to ISO 15754 of applied and calendared graphite anode active matter used in lithium-ion batteries on a chemically pretreated copper containing substrate and compared with results from the same test made with a copper containing substrate, which had not been subjected to a chemical pretreatment.

### 5. Interface Resistivity

Interface resistivity was measured by a HIOKI Multipin System.

### 6. Potentiodynamic Scan

A potentiodynamic scan was performed by a GAMRY Instrument in the scan range of −250 to 300 mV with a scan rate of 5 mV/s at neutral pH on a chemically pretreated copper containing substrate according to ISO 17475 and compared with results from the same test made with a copper containing substrate, which had not been subjected to a chemical pretreatment in order to measure the passivation efficiency.

### EXAMPLES

The following examples further illustrate the invention but are not to be construed as limiting its scope.

### 1. Chemical Pretreatment Compositions

Several exemplary chemical pretreatment compositions have been prepared, i.e., compositions A1 to A4, B1, B2 and C.

### Composition A1

A hexafluorozirconic acid containing composition was diluted in deionized water to achieve a zirconium concentration of 500 ppm (calculated as Zr). The pH value was adjusted to 3.6 to 3.8 by adding a diluted sodium carbonate solution, resulting in a free fluoride concentration of 48 to 55 ppm. The resulting conductivity was measured to be between 1400 and 1500 μS/cm.

### Composition A2

A zirconium nitrate containing composition was diluted in deionized water to achieve a zirconium concentration of 270 ppm (calculated as Zr). The pH value of the fluoride free composition was adjusted to 2.8 to 3.0 by adding a diluted sodium carbonate solution.

### Composition A3

A hexafluorozirconic acid, ammonium molybdate and a poly(meth)acrylic acid polymer containing composition was diluted in deionized water to achieve a zirconium concentration of 380 ppm (calculated as Zr) and a molybdenum concentration of 40 ppm (calculated as Mo). The pH value was adjusted to 3.5 to 3.7 by adding a diluted ammonium bifluoride solution, resulting in a free fluoride concentration of 70 to 80 ppm and a conductivity between 1250 and 1300 μS/cm. The poly(meth)acrylic acid polymer had a weight average molecular weight of about 250,000 g/mol and was commercially available.

### Composition A4

A hexafluorotitanic acid, ammonium molybdate and poly(meth)acrylic acid polymer containing composition was diluted in deionized water to achieve a titanium concentration of 250 ppm (calculated as Ti) and a molybdenum concentration of 40 ppm (calculated as Mo). The pH value was adjusted to 3.6 to 3.8 by adding a diluted ammonium bifluoride solution, resulting in a free fluoride concentration of 70 to 80 ppm and a conductivity between 1250 and 1300 μS/cm. The poly(meth)acrylic acid polymer had a weight average molecular weight of about 250,000 g/mol and was commercially available.

### Composition B1

A pre-condensate made from an amino silane and a bis-functional silane was diluted with deionized water to achieve a silicon concentration of 4000 ppm (calculated as Si). The pH value was adjusted to 6.0 to 6.4 by adding a diluted ammonium hydrogen carbonate solution. The resulting conductivity was measured to be between 1870 and 2140 μS/cm.

### Composition B2

A pre-condensate made from N-(2-aminoethyl)-3-aminopropyltrimethoxysilane and bis[3-(trimethoxysilyl) propyl]amine) was diluted with deionized water to achieve a silicon concentration of 300 ppm (calculated as Si). The pH value was adjusted to 3.9 to 4.2 by adding a diluted sodium carbonate solution. The resulting conductivity was measured to be between 1300 and 1400 μS/cm.

### Composition C

A mixture of a pre-condensate made from N-(2-aminoethyl)-3-aminopropyltrimethoxy-silane and bis[3-(trimethoxysilyl) propyl]amine) and a hexafluorozirconic acid containing composition was diluted with deionized water to achieve a silicon concentration of 150 ppm (calculated as Si) and a zirconium concentration of 20 ppm (as Zr). The pH value was adjusted to 3.3 to 3.5 by adding a diluted sodium carbonate solution. The resulting conductivity was measured to be between 1400 and 1500 μS/cm.

### 2. Method of Pretreatment Including Chemical Pretreatment

2.1 As substrates, copper workpieces were used, either in form of a thin foil or in form of a bar. The following specific substrates were used:

| | |
|---|---|
| Substrate S1: | copper foil made of copper alloy with >98% |
| | copper content, non-plated, 6 μm thickness, |
| Substrate S2: | copper foil made of pure copper, nickel- and |
| | zinc-plated, 18 μm thickness, |
| Substrate S3: | copper foil made of pure copper, non-plated, |
| | 10 μm thickness, |
| Substrate S4: | copper foil made of pure copper, non-plated, |
| | 18 μm thickness, and |
| Substrate S5: | copper bar made of copper alloy with >98% copper |
| | content, nickel-and zinc-plated, 3 mm thickness. |

2.2 Substrate S5 was cleaned by dipping into a cleaning bath prepared from an aqueous cleaning solution of Gardoclean® S5176 available from Chemetall GmbH at 70 °C for 10 minutes and then rinsed with deionized water for 1 minute before proceeding with pickling step as outlined hereinafter.
2.3 The surface-purified substrate S5 and each of the substrates S1 to S4 were pickled by using a solution containing sulfuric acid (20 wt.-%) and hydrogen peroxide (0.9 to 3.0 wt.-%) for 5 to 60 seconds at ambient temperature and then subsequently rinsed by deionized water for 1 minute, then deoxidized by using a solution containing sulfuric acid (5 wt.-%) for about 30 seconds at ambient temperature and then subsequently rinsed by deionized water for 1 minute. Afterwards drying using compressed air was performed. The success of the cleaning was checked by water-break behavior when removing the substrates from the last deionized water rinse. The least aggressive but successful pickling condition was chosen in pretests for each individual type of substrate.
2.4 Then, a chemical pretreatment was performed by immersing the substrates into baths of one of the chemical pretreatment compositions A1 to A4, B1, B2 and C in such a way, that a part of the workpiece is sticking out of the bath in each case. In case of foils, non-conductive sample holders made from polyamide were used. The bath was kept at ambient temperature between 2° and 23 °C. Counter electrodes made from stainless steel or platinated niobium were also immersed in the baths with a part sticking out of the bath as well. These counter electrodes were arranged in such a way, that they were parallel to each other with the copper workpieces to be treated also parallel to and in the middle of the counter electrodes. If the chemical pretreatment is intended to take place on only one side (surface) of the copper workpiece, only one parallel counter electrode is needed. In the case of two counter electrodes, they were connected either by a stainless-steel holder or via electrical cables in such a way, that the to-be applied electrical current flows in same strength through both. In all shown experiments both sides of the substrates were pretreated. The counter electrodes, which were larger in size than the copper workpiece to be treated, were connected to a laboratory power supply unit as positive electrode, also defined as anode in an electrolytic cell. The copper workpieces were connected as negative electrode, also defined as cathode in an electrolytic cell. All connections were made via electric cables equipped with clamps above the level of the treatment liquid. The bath was non-agitated or agitated in such a way, that there was a quasi-laminar flow of the composition present in the bath around the copper workpiece to be treated. The immersion of the copper workpiece to be treated was performed while the current was off, then a low current was applied for a given time, then switched off. After this treatment, the copper workpieces were removed from the treatment bath and either transferred to a deionized water treatment (by rinse and/or immersion) and/or force-dried with clean compressed air, to remove excess adhering treatment liquid. To remove lingering amounts of water, the copper substrates were dried in a convection oven at 40 °C for 20 minutes, except for composition B1, where 85 °C was used instead of 40 °C.

In Table 1 the conditions used for each experiment (run) performed are summarized. Runs 4, 5, 12 and 13 are comparative runs (no current was applied).

TABLE 1

| | | | | Rinsing/ | |
|---|---|---|---|---|---|
| | | Chemical | Time of chemical | immersing | |
| | Substrate | pretreatment | pretreatment, | with | Drying with |
| | (workpiece) | composition | voltage and | deionized | compressed |
| Run | used | used | current applied | water | air |
| 1 | S1 | A1 | 20 s at 3.5 V with | yes, for 30 s | yes |
| | | | 6 A/m² | | |
| 2 | S1 | A1 | 10 s at 3.5 V with | yes, for 30 s | yes |
| | | | 6 A/m² | | |
| 3 | S1 | A2 | 30 s at 4.0 V with | yes, for 30 s | yes |
| | | | 10 A/m² | | |
| 4 | S2 | A3 | 30 s without | no | yes |
| | | | current | | |
| 5 | S2 | A3 | 30 s without | yes, for 30 s | yes |
| | | | current | | |
| 6 | S2 | A3 | 30 s at 3.5 V with | no | yes |
| | | | 12 A/m² | | |
| 7 | S2 | A3 | 30 s at 3.5 V with | yes, for 30 s | yes |
| | | | 12 A/m² | | |
| 8 | S2 | A4 | 30 s at 3.5 V with | yes, for 30 s | yes |
| | | | 7 A/m² | | |
| 9 | S3 | B1 | 30 s at 4.0 V with | no | yes, followed |
| | | | 13 A/m² | | by 20 min at |
| | | | | | 85 °C |
| 10 | S3 | B1 | 30 s at 4.0 V with | yes, for 30 s | yes, followed |
| | | | 13 A/m² | (2x) | by 20 min at |
| | | | | | 85 °C |
| 11 | S4 | B2 | 30 s at 4.0 V with | yes, for 30 s | yes |
| | | | 7 A/m² | (2x) | |
| 12 | S1 | C | 30 s without | no | yes |
| | | | current | | |
| 13 | S1 | C | 30 s without | yes, for 30 s | yes |
| | | | current | (2x) | |
| 14 | S1 | C | 30 s at 3.5 V with | no | yes |
| | | | 10 A/m² | | |
| 15 | S1 | C | 30 s at 3.5 V with | yes, for 30 s | yes |
| | | | 10 A/m² | (2x) | |
| 16 | S5 | C | 30 s at 4.0 V with | yes, for 30 s | yes |
| | | | 15 A/m² | (5x) | |

### 3. Investigation of Properties of the Chemically Pretreated Substrates Obtained

3.1 The coating weights of the layers present on the surfaces of each of the substrates were determined according to the method disclosed in the method section. The results are summarized in Table 2. Runs 4, 5, 12 and 13 are comparative runs (no current was applied). In case of coating weights of Zr and Ti, these have been calculated as metal in each case. In case of coating weights of Si, these have been calculated as Si (element) in each case.

| Run | Coating weight [mg/m²] | |
|---|---|---|
| 1 | 36 | (Zr) |
| 2 | 15 | (Zr) |
| 3 | 20 | (Zr) |
| 4 | 8 | (Zr) |
| 5 | <1 | (Zr) |
| 6 | 72 | (Zr) |
| 7 | 55 | (Zr) |
| 8 | 5 | (Ti) |
| 9 | 130 | (Si) |
| 10 | 10 | (Si) |
| 11 | 13 | (Si) |

| | |
|---|---|
| 12 | 3 (Zr) and 4 (Si) |
| 13 | <1 Zr) and <1 (Si) |
| 14 | 24 (Zr) and 13 (Si) |
| 15 | 12 (Zr) and 6 (Si) |
| 16 | 12 (Zr) and 7 (Si) |

3.2 Adhesion properties of some of the chemically pretreated substrates were tested as well.

The substrate obtained after run 16 was subjected to the adhesion force test described in the method section. It was found that the adhesion force was increased by 44% in case of the substrate obtained after run 16 compared to the same substrate, which had not been subjected to the chemical pretreatment.

In addition, the substrate obtained after run 1 was subjected to the tensile force test described in the method section. It was found that the adhesion, measured in N/mm², was increased by 12% in case of the substrate obtained after run 1 compared to the same substrate, which had not been subjected to the chemical pretreatment.
3.3 The interface resistivity of some of the chemically pretreated substrates was tested as well according to the method described in the method section. The interface resistivity of the substrate obtained after run 1, on which a graphite anode active matter as used in Li-ion batteries was applied and calendared, was measured to be 3.3 mΩ/cm². The interface resistivity of the substrate obtained after run 11, on which a graphite anode active matter as used in Li-ion batteries was applied and calendared, was measured to be 4.4 mΩ/cm².
3.4 A potentiodynamic scan was performed in case of the chemically pretreated substrate obtained after run 1. The passivation efficiency compared to the same substrate, which had not been subjected to the chemical pretreatment, was increased by 13% when considering the value of the corrosion current as log icorr.

1. A method for pretreatment of substrates containing copper and/or at least one alloy thereof, the method comprising
1) contacting at least one surface of at least one substrate, said surface optionally bearing at least one plating layer, at least in portion with an aqueous composition and thereby forming a film at least in portion on said surface, wherein the at least one surface of the substrate is made of copper and/or at least one alloy thereof,
wherein the aqueous composition contains at least 70 wt.-% of water, based on its total weight, and comprises, besides water, at least one of constituents a1) and a2), which are different from one of another, namely
at least one of zirconium, titanium, and hafnium cations as constituent(s) a1) in an amount in a range of from 5 to 2000 mg/L, in each case calculated as metal, and/or
at least one organosilane and/or at least one hydrolysis and/or condensation product thereof as constituent(s) a2), and
2) optionally rinsing the film obtained after step 1) with water, and/or
3) optionally drying the film obtained after step 1) or after optional step 2),
wherein contacting step 1) is performed in an electrolytic cell arrangement with the substrate containing copper and/or at least one alloy thereof being the cathode during performance of step 1).

2. The method according to claim 1, wherein the aqueous composition comprises at least one of zirconium and titanium cations as constituent(s) a1).

3. The method according to claim 1, wherein the aqueous composition further comprises fluoride anions including complex fluoride anions as constituent a3).

4. The method according to claim 3, wherein the aqueous composition comprises fluoride anions being present therein as complex fluoride anions as constituent a3), wherein the fluoride anions are coordinated to at least one of zirconium, titanium and hafnium cations being also present in the composition as constituent(s) a1).

5. The method according to claim 1, wherein the composition comprises the at least one organosilane and/or a hydrolysis and/or condensation product thereof as constituent(s) a2) in an amount in a range of from 5 to 20 000 mg/L, in each case calculated as elemental silicon.

6. The method according to claim 1, wherein the electrolytic treatment according to step 1) is performed with direct current.

7. The method according to claim 1, wherein a period of time the surface is contacted with the aqueous composition in step 1) is from 1 second to 5 minutes, and/or wherein a temperature of the aqueous composition used in step 1) is of from 5 to 90 °C.

8. The method according to claim 1, wherein the aqueous composition used in step 1) has a pH value in a range of from 1.0 to 9.0.

9. The method according to claim 1, wherein the film obtained after step 1) or after optional steps 2) and/or 3) has a dry film thickness corresponding to a coating weight in a range of from 0.5 to 500 mg/m², determined as tracer element(s) via XRF measurements.

10. The method according to claim 1, wherein the optionally present plating layer is made of copper, zinc, nickel, tin, and/or an alloy of one or more of the aforementioned metals.

11. The method according to claim 1, wherein the substrate is in a form of a foil, a coil, or a mostly flat part.

12. A method of applying at least one coating film onto at least one surface of a substrate, the method comprising at least step 1) and optionally step 2) and/or step 3) as defined in claim 1, and, further comprising
4) applying a coating material composition comprising at least one film-forming polymer onto a film obtained after step 1) or obtained after optional step 2) and/or 3).

13. A substrate obtained by the pretreatment method according to claim 1.

14. A component obtained from the substrate of claim 13, wherein the component is selected from the group consisting of current collectors, conductors, copper clad laminates, and anode materials.

15. A method of using the aqueous composition as defined in claim 1, the method comprising using the aqueous composition in connection with contacting step 1) for electrolytically forming a film at least in portion onto a surface of a substrate, said surface optionally bearing at least one plating layer, wherein the at least one surface of the substrate is made of copper and/or at least one alloy thereof, wherein the substrate serves as cathode for the electrolytic application.

16. The method according to claim 1, wherein the aqueous composition comprises at least one of zirconium and titanium cations, as constituent(s) a1), in an amount in a range of from 7.5 to 1500 mg/L, calculated as metal.

17. The method according to claim 1, wherein the electrolytic treatment according to step 1) is performed with direct current, using a voltage in a range of from 2 to 10 V, while generating a current density in a range of from 2 to 30 A/m².

18. A substrate obtained by the pretreatment method according to claim 12.

19. A component obtained from the substrate of claim 18, wherein the component is selected from the group consisting of current collectors, conductors, copper clad laminates, and anode materials.

20. The component according to claim 14, wherein the component is used in rechargeable battery cells.
